(19) United States
(12) Patent Application Publication
(10) Pub. No.: US 2013/0214621 A1
(43) Pub. Date: Aug. 22, 2013

(54) MOTOR

(71) Applicant: Nidec Sankyo Coporation, (US)

(72) Inventor: Kazumi FURUBAYASHI, Nagano (JP)

(73) Assignee: NIDEC SANKYO CORPORATION, Nagano (JP)

(21) Appl. No.: 13/771,548

(22) Filed: Feb. 20, 2013

(30) Foreign Application Priority Data
Feb. 20, 2012 (JP) 2012-34337

(51) Int. Cl. H02K 5/02; H02K 5/22

(52) U.S. Cl. CPC H02K 5/02; H02K 5/225
USPC 310/43; 310/89; 310/71

(57) ABSTRACT

A motor may include a motor main body in which a rotor may be accommodated on an inner side of a motor case, and an antireflection layer which may be matted and provided with a light-absorbing property and which may cover at least a part of an outer face of the motor case.

### CROSS REFERENCE TO RELATED APPLICATION

The present invention claims priority under 35 U.S.C. §119 to Japanese Application No. 2012-034337 filed Feb. 20, 2012, the entire content of which is incorporated herein by reference.

### FIELD OF THE INVENTION

At least an embodiment of the present invention may relate to a motor.

### BACKGROUND

A stepping motor which is utilized for driving a lens in a digital camera, a video camera or the like is sometimes directly mounted on an inside of a lens-barrel. In this case, it is required that reflection light by an outer face of the motor case is prevented from being incident on the imaging element. Therefore, a structure has been proposed in which a magnetic pole unit provided with pole teeth is covered with resin by injection molding and its resin surface is made to be a satin finished (pear-skin finished) surface, or carbon black is added to the resin (see Japanese Patent Laid-Open No. 2003-32990). Further, a structure has been proposed in which etching utilizing ferric chloride is performed on an outer face of a metal motor case and the outer face is dyed black with a black coating film containing oxide or sulfide (see Japanese Patent Laid-Open No. 2006-129607).

However, in the structure described in the former Patent Literature, a special process and a large-scaled equipment are required in which the magnetic pole unit provided with the pole teeth is put in a die and performed with injection molding and thus its cost is increased. Further, in the structure described in the latter Patent Literature, a special wet process and a special chemical are required, for example, the etching process for the motor case is required and thus the cost is increased. Further, in both of the structures described in Patent Literatures, components for a normal stepping motor are not used in common and thus, also in this point, the cost is increased.

### SUMMARY

In view of the problem described above, at least an embodiment of the present invention may advantageously provide a motor capable of preventing reflection of its outer face without requiring a special process and a special chemical.

According to at least an embodiment of the present invention, there may be provided a motor including a motor main body in which a rotor is accommodated on an inner side of a motor case, and a matted antireflection layer having a light-absorbing property, and the antireflection layer covers at least a part of an outer face of the motor case.

In the motor in at least an embodiment of the present invention, at least a part of an outer face of the motor case is covered with the antireflection layer. Therefore, occurrence of malfunction such that the light reflected by the motor case is incident on an imaging element is prevented by disposing the motor at the time of mounting the motor on an optical device or the like so that the antireflection layer is arranged on a side where light is incident. Further, in order to provide the antireflection layer, a simple work is sufficient in which the motor case is covered with the antireflection layer after the motor has been assembled or in the middle of assembling of the motor and thus a special process such as injection molding or etching process is not required. Further, all common components of a normal motor may be used except the antireflection layer. Therefore, cost is not largely increased for preventing reflection by the outer face of the motor case.

In at least an embodiment of the present invention, the antireflection layer is a cover which covers the outer face of the motor case, and an outer face of the cover is structured in an antireflection surface having the light-absorbing property which is provided with projected and recessed portions for matting. According to this structure, a simple work is sufficient in which the outer face of the motor case is covered by a member having a simple structure, i.e., a cover. Further, the cover may be manufactured in a step different from manufacturing steps for the motor main body and thus the cost is not increased largely.

In at least an embodiment of the present invention, the cover is a tube-shaped cover in which the motor case is fitted into an inner side of the tube-shaped cover. According to this structure, the tube-shaped cover is surely attached to the motor case. Specifically, it may be structured that the cover is provided with a bottom plate part, which is superposed on an end face on an opposite-to-output side of the motor, and a side plate part in a cylindrical tube shape which is extended toward an output side in the motor axial line direction from an outer circumferential edge of the bottom plate part, and the side plate part of the cover covers the outer face of the motor case.

In at least an embodiment of the present invention, the cover is fixed to the outer face of the motor case with an adhesive. According to this structure, a special structure such that the motor case and the cover are engaged with each other is not required and thus the cover is formed in a simple structure and a motor case of a normal motor may be used as the motor case.

In at least an embodiment of the present invention, the motor case is provided with a protruded part which is protruded to an outer side in a radial direction at an opening edge of a tube-shaped body part which is extended in a motor axial line direction, the cover is formed so as to cover at least the protruded part, and a gap space structuring a reservoir part for the adhesive is formed between the cover and an outer face of the tube-shaped body part by the protruded part. According to this structure, the adhesive is reserved in the reservoir part for the adhesive.

In at least an embodiment of the present invention, the motor case is structured so that the opening edges of the tube-shaped body parts of two cup-shaped members are arranged so as to face each other in the motor axial line direction. According to this structure, the reservoir part for the adhesive is structured between the cover and the outer face of the tube-shaped body part by the protruded parts provided in two cup-shaped members. Specifically, the motor main body is structured so that a first bobbin and a second bobbin in a ring shape around which a coil is wound are disposed so as to be superposed on each other in the motor axial line direction, and an inner stator core in a ring shape which is made of a magnetic plate and the cup-shaped member as an outer stator core which is made of a magnetic plate are disposed so as to be superposed on each other on both sides in the motor axial line direction of each of the first bobbin and the second bobbin, the cup-shaped member includes an end plate part in a circular ring shape, the tube-shaped body part which is extended in the motor axial line direction from an outer circumferential edge of the end plate part, and a plurality of pole teeth which are protruded in the motor axial line direction from an inner edge of the end plate part, and a plurality of pole teeth protruded from an inner edge of the inner stator core and the pole teeth formed in the cup-shaped member are alternately juxtaposed in a circumferential direction on inner peripheral faces of the first bobbin and the second bobbin. The protruded part is formed by protruding an opening edge of the tube-shaped body part to an outer side in a radial direction and, alternatively, the protruded part is formed by protruding an outer circumferential edge of the inner stator core to an outer side in the radial direction with respect to the tube-shaped body part. A gap space which structures the reservoir part for the adhesive is easily formed by utilizing the protruded part.

In at least an embodiment of the present invention, a terminal block holding a plurality of terminal pins around which an end part of the coil is wound is protruded to an outer side from the opening edge of the tube-shaped body part, the cover is formed with a cut-out portion for protruding the terminal block to the outer side from the tube-shaped body part, and the terminal block is disposed so that a protruding position of the terminal block from the tube-shaped body part is set on a side where light is not advanced when the motor is mounted on an optical device on which the motor is to be mounted. According to this structure, even when light is advanced toward the motor case, the light is prevented from being reflected by the terminal pins and by the motor main body through the cut-out portion for protruding the terminal block to be incident on the imaging element.

In at least an embodiment of the present invention, the cover is a resin molded product whose outer face is formed with a large number of minute projected and recessed portions for matting. In this case, it is preferable that thickness of a side plate part of the resin molded product which covers the outer face of the motor case is set in a range of 0.15 mm-1.0 mm. Further, it may be structured that the minute projected and recessed portions for matting are formed so that minute projected and recessed portions formed on a surface of a die are transferred to the outer face of the side plate part when the resin molded product is molded by the die. In this case, the cover having an antireflection surface having a light-absorbing property which is formed with projected and recessed portions for matting is easily obtained.

In at least an embodiment of the present invention, the cover is provided with an engagement part which is engaged with the motor main body for connecting the cover with the motor main body. According to this structure, even when an adhesive or the like is not used, the motor case is maintained in a covered state by the cover. Further, even when an adhesive is used, the cover and the motor main body are connected with each other until the adhesive is solidified.

In at least an embodiment of the present invention, the engagement part is formed so that the cover is thermally deformed toward a stepped part of the motor main body. According to this structure, an engagement part is not required to be previously provided in the cover and thus the structure of the cover is simplified. Further, when the resin molded product in which minute projected and recessed portions for matting are formed on its outer face is used as the cover, the cover is thermally deformed easily and the resin molded product is easily manufactured.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a) and 1(b) are explanatory views showing a motor in accordance with an embodiment of the present invention which is viewed from an output side.

FIGS. 2(a) and 2(b) are explanatory views showing a motor in accordance with an embodiment of the present invention which is viewed from an opposite-to-output side.

FIGS. 3(a), 3(b) and 3(c) are explanatory views showing a motor main body of a motor in accordance with an embodiment of the present invention.

FIGS. 4(a) and 4(b) are explanatory views showing a fixing structure of a tube-shaped cover of a motor in accordance with an embodiment of the present invention.

### DETAILED DESCRIPTION OF THE PREFERRED EMBODIMENTS

A motor in accordance with an embodiment of the present invention will be described below with reference to the accompanying drawings. In the following descriptions, in a motor axial line direction, a side where a rotation shaft is protruded is an output side and a side which is opposite to the side where the rotation shaft is protruded is an opposite-to-output side.

(Entire Structure)

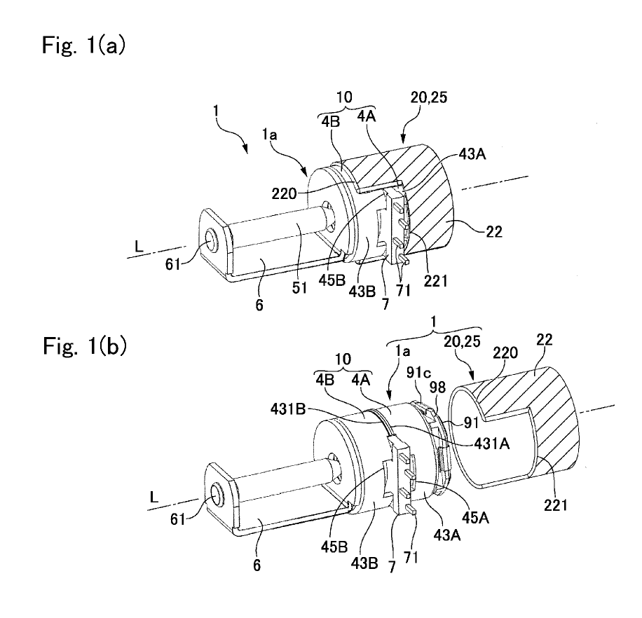

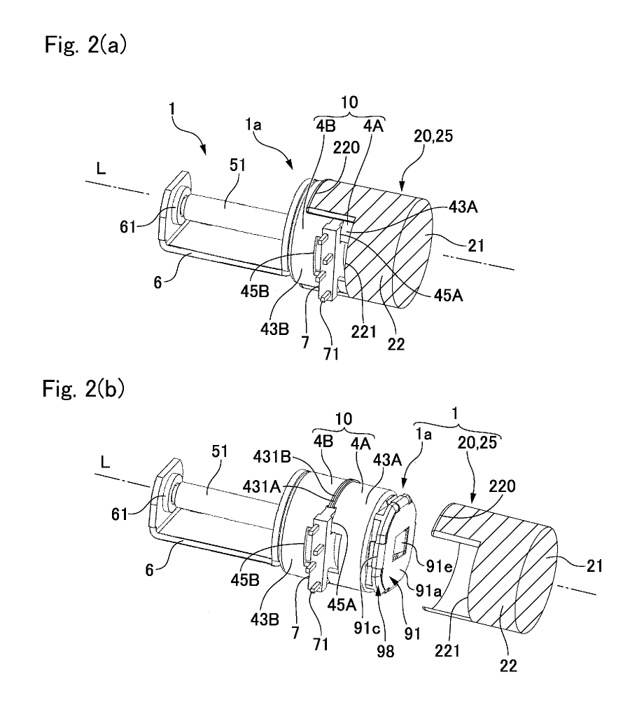

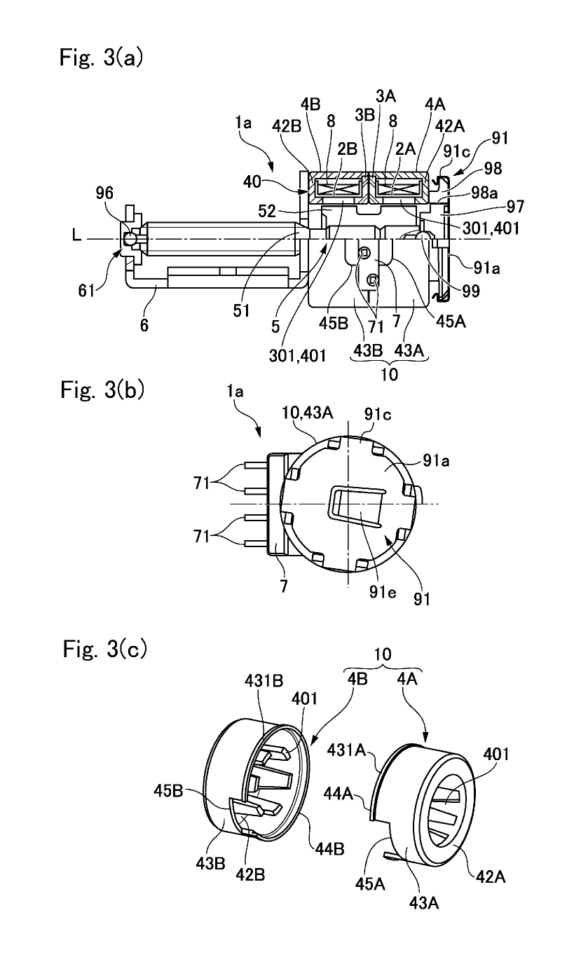

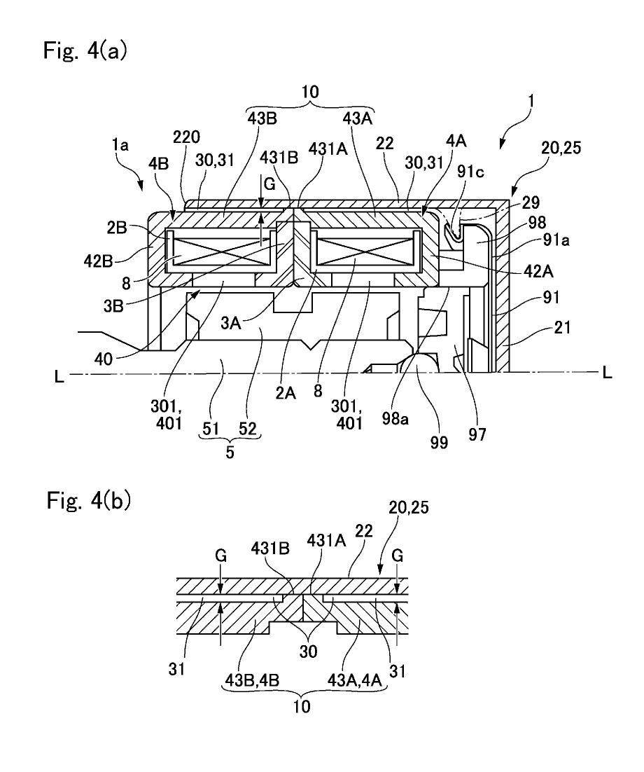

FIGS. 1(a) and 1(b) are explanatory views showing a motor in accordance with an embodiment of the present invention which is viewed from an output side. FIG. 1(a) is a perspective view showing a motor and FIG. 1(b) is its exploded perspective view. FIGS. 2(a) and 2(b) are explanatory views showing a motor in accordance with an embodiment of the present invention which is viewed from an opposite-to-output side. FIG. 2(a) is a perspective view showing a motor and FIG. 2(b) is its exploded perspective view. FIGS. 3(a), 3(b) and 3(c) are explanatory views showing a motor main body of a motor in accordance with an embodiment of the present invention. FIG. 3(a) is a cross-sectional view showing a motor main body, FIG. 3(b) is a side view showing a motor main body which is viewed from an opposite-to-output side, and FIG. 3(c) is an explanatory view showing cup-shaped members which structure a motor case. FIGS. 4(a) and 4(b) are explanatory views showing a fixing structure of a tube-shaped cover of a motor in accordance with an embodiment of the present invention. FIG. 4(a) is an enlarged cross-sectional view showing a side face part of a motor and FIG. 4(b) is a further enlarged explanatory view showing a side face part of a motor. In FIGS. 1(a) and 1(b), and FIGS. 2(a) and 2(b), an antireflection surface described below is represented with right side upward slanted lines.

In FIGS. 1(a) and 1(b), and FIGS. 2(a) and 2(b), a motor 1 to which at least an embodiment of the present invention is applied is a small stepping motor which is used in a digital camera, a digital video camera or the like. The motor 1 is structured of a motor main body 1a and a cover 20 which covers a motor case 10 of the motor main body 1a. In this embodiment, the cover 20 is a tube-shaped cover. Further, in this embodiment, the cross section of the motor case 10 is circular and thus the cover 20 is a cylindrical tube-shaped cover. The cover 20 is used as an antireflection layer 25 which will be described below.

As shown in FIGS. 3(a), 3(b) and 3(c) and FIGS. 4(a) and 4(b), the motor main body 1a includes a stator 40 in a cylindrical tube shape and, in the stator 40, a first bobbin 2A and a second bobbin 2B around which a coil 8 is wound and which is formed in a ring shape are disposed so as to be superposed on each other in a motor axial line “L” direction. In the stator 40, an inner stator core 3A, which is formed in a ring shape and is made of a magnetic plate, and a cup-shaped member 4A which is made of a magnetic plate as an outer stator core are disposed so as to be superposed on each other on both sides in the motor axial line “L” direction of the first bobbin 2A. An inner stator core 3B, which is formed in a ring shape and is made of a magnetic plate, and a cup-shaped member 4B which is made of a magnetic plate as an outer stator core are disposed so as to be superposed on each other on both sides in the motor axial line “L” direction of the second bobbin 2B. Pole teeth 301 of the inner stator cores 3A and 3B and pole teeth 401 of the cup-shaped members 4A and 4B are alternately juxtaposed to each other in a circumferential direction on inner peripheral faces of the first bobbin 2A and the second bobbin 2B. In this manner, the stator 40 is structured in a cylindrical tube shape and a rotor 5 is coaxially disposed on an inner side of the stator 40.

The rotor 5 is provided with a rotor magnet 52 around a base end side (opposite-to-output side) of a rotation shaft 51 and the rotor magnet 52 faces the pole teeth 301 and 401 of the stator 40 (the inner stator cores 3A and 3B and the cup-shaped members 4A and 4B) through a predetermined distance on the inner side of the stator 40.

(Structure of Motor Case 10 and the Like)

The cup-shaped member 4A is provided with a circular ring shaped end plate part 42A and a tube-shaped body part 43A which is extended from an outer circumferential edge of the circular ring-shaped end plate part 42A toward an output side in the motor axial line “L” direction. A plurality of the pole teeth 401 is protruded from an inner edge of the end plate part 42A toward the output side. The cup-shaped member 4B is provided with a circular ring shaped end plate part 42B and a tube-shaped body part 43B which is extended from an outer circumferential edge of the circular ring-shaped end plate part 42B toward an opposite-to-output side in the motor axial line “L” direction. A plurality of the pole teeth 401 is protruded from an inner edge of the end plate part 42B toward the opposite-to-output side.

The cup-shaped members 4A and 4B which are structured as described above are arranged so that opening parts 44A and 44B of the tube-shaped body parts 43A and 43B are faced each other in the motor axial line “L” direction to structure the motor case 10 and the coils 8 and the rotor 5 are accommodated in an inside of the motor case 10.

Cut-out portions 45A and 45B are formed at opening edges of the tube-shaped body parts 43A and 43B of the cup-shaped members 4A and 4B. A terminal block 7 is protruded from the motor case 10 to an outer side in a radial direction through the cut-out portions 45A and 45B. The terminal block 7 is structured of a resin portion which is integrally formed with the first bobbin 2A and the second bobbin 2 B and the terminal block 7 holds a plurality of terminal pins 71 around which an end part of the coil 8 is wound. The terminal pins 71 are connected with a wiring member (not shown) such as a flexible circuit board or a cable.

(Structure of Bearings 61 and 97 and the Like)

A plate 6 is fixed to the end plate part 42B of the cup-shaped member 4B of the motor main body 1a and an end part on an output side of the rotation shaft 51 is supported by a bearing 61 which is held in a tip end side bent portion of the plate 6 through a steel ball 96. The plate 6 is used as a mounting part when the motor 1 is mounted on an optical device such as a digital camera or a video camera.

A shaft end on the opposite-to-output side (side of first bobbin 2A) of the rotation shaft 51 in the motor axial line “L” direction is supported by a bearing 97 through a steel ball 99. A bearing holder 98 made of a sintered metal body is disposed on an opposite-to-output side with respect to the stator 40 and the bearing 97 is fitted to a through hole 98a of the bearing holder 98. The bearing 97 is movable in the motor axial line “L” direction in an inside of the through hole 98a. The bearing holder 98 is fixed to the cup-shaped member 4A by welding.

In this embodiment, a pressurization-applying member 91 formed of a metal plate is disposed on an further opposite-to-output side with respect to the bearing holder 98 so that at least a part of the pressurization-applying member 91 is overlapped with the bearing holder 98. The pressurization-applying member 91 is provided with an end plate part 91a and pawl parts 91c which are extended to a bearing holder 98 side from an outer circumferential edge of the end plate part 91a and are engaged with an outer peripheral end part of the bearing holder 98. A plate spring part 91e is cut and bent from the end plate part 91a of the pressurization-applying member 91 toward a side of the bearing 97 and the plate spring part 91e urges the bearing 97 in the inside of the through hole 98a toward the rotation shaft 51 (output side) and applies pressurization to the bearing 97.

(Structure of Antireflection Layer)

As shown in FIGS. 1(a) and 1(b), FIGS. 2(a) and 2(b) and FIGS. 4(a) and 4(b), in the motor 1 in this embodiment, an outer face of the motor case 10 is a metal surface having a high reflectivity. However, when the motor 1 is mounted on a digital camera, a video camera or the like, in order to prevent that light is reflected by the motor main body 1a to be incident on an imaging element, the matted antireflection layer 25 having a light-absorbing property covers at least a part of the outer face of the motor case 10. More specifically, a cover 20 as the antireflection layer 25 covers an outer face of the motor case 10. The cover 20 is a black resin molded product whose surface is formed with a large number of minute projected and recessed portions for matting. For example, the cover 20 is a heat-resistant resin molded product made of polycarbonate resin, polyacetal resin or the like and its thickness is, for example, about 0.2 mm. It is preferable that the cover 20 is provided with thickness as small as possible in order to reduce the increase of a size in the radial direction of the motor 1. However, taking easiness of handling of the resin molded product into consideration, the thickness of a side plate part 22 described below is preferable to be set in a range of 0.15 mm-1.0 mm. In this embodiment, the cover 20 is fixed to the outer face of the motor case 10 by an adhesive 30.

The cover 20 is provided with a bottom plate part 21, which is superposed on the end face on the opposite-to-output side of the motor 1 (pressurization-applying member 91), and a side plate part 22 in a cylindrical tube shape which is extended from an outer circumferential edge of the bottom plate part 21 toward an output side in the motor axial line “L” direction. The side plate part 22 covers the side face (outer face) of the motor case 10. Further, a large number of minute projected and recessed portions for matting is formed on a surface (outer face) of the bottom plate part 21 and a surface (outer face) of the side plate part 22 of the cover 20. In this embodiment, the projected and recessed portions are formed in a satin finished (pear-skin finished) surface shape. On the other hand, an inner face of the bottom plate part 21 and an inner face of the side plate part 22 is formed in a smooth face which is not formed with the projected and recessed portions for matting. In this embodiment, the minute projected and recessed portions for matting are formed so that, when the cover 20 is die-molded, the minute projected and recessed portions formed on a portion of the die contacting with the outer face of the bottom plate part 21 and the outer face of the side plate part 22 are transferred. Further, the color of the cover 20 is black and the cover 20 is provided with a light-absorbing property.

Therefore, even when light is advanced toward the side face (outer face) of the motor case 10 and toward the end face (pressurization-applying member 91) on the opposite-to-output side of the motor 1, the cover 20 absorbs the light and its reflection is prevented. Accordingly, in the motor 1 in this embodiment, in a case that the motor 1 is mounted on a digital camera, a video camera or the like, even when light is advanced toward the side face of the motor case 10 and the end face (pressurization-applying member 91) on the opposite-to-output side of the motor 1, the light is prevented from being reflected by the motor 1 to be incident on the imaging element.

In this embodiment, the terminal block 7 is protruded to an outer side in a radial direction from the motor case 10 at a position corresponding to the joint of the cup-shaped members 4A and 4B. On the other hand, a dimension in the motor axial line “L” direction of the side plate part 22 of the cover 20 is set in a dimension in which most of the motor case 10 in the motor axial line “L” direction is covered. However, a cut-out portion 221 is formed at the opening edge 220 of the side plate part 22 of the cover 20 at a portion where the terminal block 7 is located. Therefore, a portion of the side plate part 22 of the cover 20 is formed in a half tube shape which is partially superposed in the circumferential direction around the motor case 10 in a region from the portion where the terminal block 7 is located to the portion on its output side. As a result, when the cover 20 is to be fitted from an opposite-to-output side of the motor case 10 (from the pressurization-applying member 91 side), the terminal block 7 is not obstructive. Further, when the motor 1 is mounted on a digital camera, a video camera or the like, the motor 1 is disposed in a state that light is not incident on the terminal block 7. In other words, in the terminal block 7 which is integrally formed with the first bobbin 2A and the second bobbin 2B, a protruding position of the terminal block 7 in the circumferential direction from the cup-shaped members 4A and 4B is set at a position on a side where light is not incident on the terminal block 7 when the plate 6 is attached to an optical device such as a digital camera or a video camera. Therefore, even when light is advanced toward the motor 1, the light is prevented from being reflected by the terminal pins 71 to be incident on the imaging element. Further, even when the cut-out portion 221 is formed in the side plate part 22 of the cover 20 for protruding the terminal block 7 from a position where the terminal block 7 is located to its output side, the cut-out portion 221 is set to be the side where light is not advanced and thus light is prevented from being reflected by the portion of the cut-out portion 221 to be incident on the imaging element.

(Structure of Reservoir Part of Adhesive 30)

In this embodiment, an inner diameter dimension of the cover 20 is essentially the same as an outer diameter dimension of the motor case 10 and thus the side plate part 22 of the cover 20 is extended along the side face of the motor case 10. In this embodiment, the opening edges of the cup-shaped members 4A and 4B (opening edges of the tube-shaped body parts 43A and 43B) are, as shown in FIGS. 4(a) and 4(b), formed with small protruded parts 431A and 431B which are protruded to an outer side in the radial direction along the opening edge and over the entire periphery of the opening edge. Therefore, a gap space “G” structuring a reservoir part 31 for an adhesive 30 is formed between the inner peripheral face of the cover 20 and the outer faces of the tube-shaped body parts 43A and 43B by the protruded parts 431A and 431B.

In order to fix the cover 20 to the outer face of the motor case 10 by an adhesive 30 by utilizing the reservoir part 31 which is structured as described above, first, a moisture-setting adhesive, a thermosetting adhesive or an anaerobic adhesive is coated on the outer face of the motor case 10. Next, the cover 20 is fitted to the motor case 10 and, in this state, the cover 20 is slid along the motor case 10 and the adhesive 30 is spread over between the motor case 10 and the cover 20. In this case, in order to prevent protrusion to the outer side of the adhesive 30 by the protruded parts 431A and 431B, it is preferable that the adhesive 30 is applied to only the outer face of the tube-shaped body part 43A. However, even when the adhesive 30 is applied to the outer face on the protruded part 431B side of the tube-shaped body part 43B, when the amount and area are appropriately set, the protrusion of the adhesive 30 can be prevented. Further, when a serious problem does not occur, the protrusion of the adhesive 30 may be left as it is. After that, the adhesive 30 is cured.

In this embodiment, the cup-shaped members 4A and 4B provided with the protruded parts 431A and 431B are obtained as follows. For example, in a manufacturing step for the cup-shaped members 4A and 4B, after drawing work is performed on a magnetic plate to form the tube-shaped body parts 43A and 43B, when the cup-shaped members 4A and 4B are to be cut out, a cutting blade is moved in parallel to the outer faces of the tube-shaped body parts 43A and 43B at a position slightly separated to the outer side in the radial direction from the outer faces of the tube-shaped body parts 43A and 43B and thereby the protruded parts 431A and 431B are obtained. Further, the protruded parts 431A and 431B may be formed in a different step from the steps in which the cup-shaped members 4A and 4B are manufactured by the drawing work. Further, the protruded parts 431A and 431B may be formed so that the inner stator cores 3A and 3B are press-fitted into the inner sides of the cup-shaped members 4A and 4B to protrude the opening edges of the cup-shaped members 4A and 4B to the outer side by the press-fitting. Alternatively, the protruded parts 431A and 431B may be formed so that outer circumferential edges of the ring-shaped parts of the inner stator cores 3A and 3B are protruded to the outer side from the cup-shaped members 4A and 4B.

(Principal Effects in this Embodiment)

As described above, in the motor 1 in this embodiment, the antireflection layer 25 having a light-absorbing property covers at least a part of the outer face of the motor case 10. Therefore, when the motor 1 is structured so that the antireflection layer 25 is disposed on a side where light is advanced at the time of mounting the motor 1 on the optical device, occurrence of malfunction such that light reflected by the motor case 10 is incident on the imaging element is prevented. Further, in order to provide the antireflection layer 25, it is sufficient that a simple work is performed in which the motor case 10 is covered with the antireflection layer 25 after the motor 1 has been assembled or in the middle of assembling of the motor 1 and thus a special process such as injection molding or etching process is not required. Further, all common components of a normal motor may be used except the antireflection layer 25. Therefore, cost is not largely increased for preventing reflection by the outer face of the motor case 10.

Further, in this embodiment, the motor case 10 is covered with the black cover 20 as the antireflection layer 25 and the outer face of the cover 20 is formed to be an antireflection surface provided with a large number of projected and recessed portions for matting. Therefore, a simple work is sufficient in which the outer face of the motor case 10 is covered with a member having a simple structure i.e., the cover 20. Further, the cover 20 may be manufactured in a different step from manufacturing steps for the motor main body 1a and thus the cost is not increased largely for preventing reflection by the outer face of the motor case 10. In addition, the cover 20 is a tube-shaped cover to which the motor case 10 is fitted on its inner side and thus the cover 20 is surely attached to the motor case 10.

Further, the cover 20 is fixed to the outer face of the motor case 10 by the adhesive 30. Therefore, a special structure for engaging the motor case 10 with the cover 20 is not required and thus the cover 20 is formed in a simple structure and the motor case 10 may use a motor case of a normal motor 1.

Further, in this embodiment, in the motor case 10, the protruded parts 431A and 431B which are protruded to an outer side in the radial direction are formed at the opening edges of the tube-shaped body parts 43A and 43B and the cover 20 covers at least to the position of the protruded parts 431A and 431B. Therefore, the gap space “G” structuring the reservoir part 31 for the adhesive 30 is formed between the cover 20 and the outer faces of the tube-shaped body parts 43A and 43B by the protruded parts 431A and 431B. Accordingly, the motor case 10 and the cover 20 are adhesively fixed to each other surely and, in comparison with a case that the protruded parts are not formed at the opening edges of the tube-shaped body parts 43A and 43B, the protrusion of the adhesive 30 can be prevented. In addition, the motor case 10 is structured so that the opening edges of two cup-shaped members 4A and 4B having the tube-shaped body parts 43A and 43B are faced each other in the motor axial direction “L” and the protruded parts 431A and 431B are formed in both of two cup-shaped members 4A and 4B. Therefore, the reservoir part 31 for the adhesive 30 is structured over a sufficient region between the cover 20 and the motor case 10 by the protruded parts 431A and 431B. Accordingly, the motor case 10 and the cover 20 are adhesively fixed to each other surely.

### Other Embodiments

In the embodiment described above, the cut-out portion 221 is formed in the tube-shaped cover as the cover 20 only in an angular range corresponding to the terminal block 7. However, the cut-out portion 221 may be formed over an angular range wider than the terminal block 7. Further, in the embodiment described above, the cut-out portion 221 is formed in only a part of the side plate part 22 of the cover 20 in the motor axial line “L” direction. However, the cut-out portion 221 may be formed over the entire region in the motor axial line “L” direction. In other words, instead of using the cover 20 in a cylindrical tube shape, a tube-shaped cover having a shape in which the side plate part 22 is divided in a circumferential direction by the cut-out portion 221, or a cover may be used which is provided with a side plate part 22 only in a part in the circumferential direction such as an angular range of 90°. Further, a cover 20 may be used in which the cut-out portion 221 is formed in a step shape. Further, in the embodiment described above, the cover 20 provided with the bottom plate part 21 is used but a cover 20 having no bottom plate part 21 may be used.

In the embodiment described above, the adhesive 30 is used for fixing the cover 20 to the motor case 10. However, it may be structured that an engagement part or the like which is engaged with a stepped part such as the terminal block 7 is provided in the cover 20 and the cover 20 is engaged and fixed to the motor case 10.

Further, as shown by the alternate long and short dash line in FIG. 4(a), it may be structured that, after the motor case 10 is covered with the cover 20, the cover 20 is partially heated and thermally deformed to an inner side to form an engagement part 29 in the cover 20 and thereby the engagement part 29 is engaged with the motor main body 1a. More specifically, the motor main body 1a is formed with a stepped part in a direction intersecting the motor axial line “L” direction by the end plate part 42A of the cup-shaped member 4A, the bearing holder 98, the pressurization-applying member 91 or the like and thus the engagement part 29 of the cover 20 may be engaged with the stepped part. Further, it may be structured that a portion of the cover 20 on the output side with respect to the protruded part 431B of the cup-shaped member 4B is heated to be thermally deformed to the inner side and the thermally deformed portion of the cover 20 is used as an engagement part which is engaged with the protruded part 431B and thereby the cover 20 is engaged with the motor main body 1a through the protruded part 431B of the cup-shaped member 4B. According to this structure, even when the adhesive 30 or the like is not used, the motor case 10 is maintained in a covered state by the cover 20. In addition, the engagement part 29 is engaged with a stepped part which is located in a direction substantially perpendicular to the motor axial line “L” direction and thus movement of the cover 20 to the output side and the opposite-to-output side in the motor axial line “L” direction is further preferably restricted. Further, even in a case that the adhesive 30 is used, the cover 20 and the motor main body 1a are connected with each other until the adhesive 30 is solidified. According to this structure, the cover 20 is not required to previously provide an engagement part 29 and thus the structure of the cover 20 is simplified.

Further, it may be structured that, after the motor case 10 is covered with the cover 20, the cover 20 is heated and melted and thereby the cover 20 and the motor case 10 are thermally welded to each other.

In the embodiment described above, a black cover 20 is used for structuring the antireflection layer 25 having a light-absorbing property. However, regarding the hue for a light-absorbing property, dark color such as brown or gray may be utilized in addition to black.

In the embodiment described above, the cover 20 is utilized as the antireflection layer 25. However, black resin layer or resin layer having another dark color may be used as the antireflection layer 25 whose surface is formed with minute projected and recessed portions for matting by coating ink containing matting agents on a side face of the motor case 10. Further, the antireflection layer 25 may be structured so that the motor case 10 is covered with a heat-shrinkable tube as the cover 20 whose surface is provided with minute projected and recessed portions for matting.

In the embodiment described above, at least an embodiment the present invention is applied to the motor 1 as an example in which the motor case 10 is structured of the tube-shaped body parts 43A and 43B of the cup-shaped members 4A and 4B which are used as an outer stator core. However, at least an embodiment of the present invention may be applied to a motor in which the motor case 10 is structured of another member which is different from the outer stator core.

In the embodiment described above, at least an embodiment of the present invention is applied to a stepping motor as the motor 1 but the present invention may be applied to a motor other than a stepping motor. Further, a cross sectional shape of the motor main body 1a is not limited to a circle and a rectangular cross sectional shape or an elliptical cross sectional shape except a circle may be utilized. In this case, it is preferable that a cross sectional shape of the cover 20 is set to be a rectangular cross sectional shape or an elliptical cross sectional shape so as to fit to the shape of the motor main body 1a.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a motor main body in which a rotor is accommodated on an inner side of a motor case; and
an antireflection layer which is matted and provided with a light-absorbing property and which covers at least a part of an outer face of the motor case.

2. The motor according to claim 1, wherein
the antireflection layer is a cover which covers the outer face of the motor case, and
an outer face of the cover is structured as an antireflection surface having the light-absorbing property which is provided with projected and recessed portions for matting.

3. The motor according to claim 2, wherein the cover is a tube-shaped cover in which the motor case is fitted into an inner side of the tube-shaped cover.

4. The motor according to claim 2, wherein the cover is fixed to the outer face of the motor case with an adhesive.

5. The motor according to claim 4, wherein
the motor case is provided with a protruded part which is protruded to an outer side in a radial direction at an opening edge of a tube-shaped body part which is extended in a motor axial line direction,
the cover is formed so as to cover at least the protruded part, and
a gap space which structures a reservoir part for the adhesive is formed between the cover and an outer face of the tube-shaped body part by the protruded part.

6. The motor according to claim 5, wherein the motor case is structured so that the opening edges of the tube-shaped body parts of two cup-shaped members are arranged so as to face each other in the motor axial line direction.

7. The motor according to claim 6, wherein
the motor main body is structured so that:
a first bobbin and a second bobbin in a ring shape around which a coil is wound are disposed so as to be superposed on each other in the motor axial line direction, and
an inner stator core in a ring shape which is made of a magnetic plate and the cup-shaped member as an outer stator core which is made of a magnetic plate are disposed so as to be superposed on each other on both sides in the motor axial line direction of each of the first bobbin and the second bobbin,
the cup-shaped member comprises:
an end plate part in a circular ring shape;
the tube-shaped body part which is extended in the motor axial line direction from an outer circumferential edge of the end plate part in a circular ring shape; and
a plurality of pole teeth which are protruded in the motor axial line direction from an inner edge of the end plate part;
a plurality of pole teeth protruded from an inner edge of the inner stator core and the pole teeth formed in the cup-shaped member are alternately juxtaposed in a circumferential direction on inner peripheral faces of the first bobbin and the second bobbin, and
the protruded part is formed by one of:
the protruded part in which an opening edge of the tube-shaped body part is protruded to an outer side in a radial direction; and
the protruded part in which an outer circumferential edge of the inner stator core is protruded to an outer side in the radial direction with respect to the tube-shaped body part.

8. The motor according to claim 7, wherein
a terminal block holding a plurality of terminal pins around which an end part of the coil is wound is protruded to an outer side from the opening edge of the tube-shaped body part,
the cover is formed with a cut-out portion for protruding the terminal block to the outer side from the tube-shaped body part, and
the terminal block is disposed so that a protruding position of the terminal block from the tube-shaped body part is set on a side where light is not advanced when the motor is mounted on an optical device on which the motor is to be mounted.

9. The motor according to claim 4, wherein the cover is a resin molded product whose outer face is formed with a large number of minute projected and recessed portions for matting.

10. The motor according to claim 9, wherein thickness of a side plate part of the resin molded product which covers the outer face of the motor case is set in a range of 0.15 mm-1.0 mm.

11. The motor according to claim 9, wherein the minute projected and recessed portions for matting are formed so that minute projected and recessed portions formed on a surface of a die are transferred to the outer face of the side plate part when the resin molded product is molded by the die.

12. The motor according to claim 9, wherein
the cover is provided with a bottom plate part, which is superposed on an end face on an opposite-to-output side of the motor, and a side plate part in a cylindrical tube shape which is extended toward an output side in the motor axial line direction from an outer circumferential edge of the bottom plate part, and
the side plate part of the cover covers the outer face of the motor case.

13. The motor according to claim 2, wherein the cover is provided with an engagement part which is engaged with the motor main body for connecting the cover with the motor main body.

14. The motor according to claim 13, wherein the engagement part is formed so that the cover is thermally deformed toward a stepped part of the motor main body.

15. The motor according to claim 14, wherein the cover is a resin molded product whose outer face is formed with a large number of minute projected and recessed portions for matting.

16. The motor according to claim 15, wherein thickness of a side plate part of the resin molded product which covers the outer face of the motor case is set in a range of 0.15 mm-1.0 mm.

17. The motor according to claim 15, wherein the minute projected and recessed portions for matting are formed so that minute projected and recessed portions formed on a surface of a die are transferred to the outer face of the side plate part when the resin molded product is molded by the die.

18. The motor according to claim 15, wherein
the cover is provided with a bottom plate part, which is superposed on an end face on an opposite-to-output side of the motor, and a side plate part in a cylindrical tube shape which is extended toward an output side in the motor axial line direction from an outer circumferential edge of the bottom plate part, and
the side plate part of the cover covers the outer face of the motor case.

19. The motor according to claim 14, wherein
the motor main body is structured so that:
a first bobbin and a second bobbin in a ring shape around which a coil is wound are disposed so as to be superposed on each other in the motor axial line direction, and
an inner stator core in a ring shape which is made of a magnetic plate and the cup-shaped member as an outer stator core which is made of a magnetic plate are disposed so as to be superposed on each other on both sides in the motor axial line direction of each of the first bobbin and the second bobbin,
the cup-shaped member comprises:
an end plate part in a circular ring shape;
the tube-shaped body part which is extended in the motor axial line direction from an outer circumferential edge of the end plate part; and
a plurality of pole teeth which are protruded in the motor axial line direction from an inner edge of the end plate part; and
a plurality of pole teeth protruded from an inner edge of the inner stator core and the pole teeth formed in the cup-shaped member are alternately juxtaposed in a circumferential direction on inner peripheral faces of the first bobbin and the second bobbin.

20. The motor according to claim 19, wherein
a terminal block holding a plurality of terminal pins around which an end part of the coil is wound is protruded to an outer side from the opening edge of the tube-shaped body part,
the cover is formed with a cut-out portion for protruding the terminal block to the outer side from the tube-shaped body part, and
the terminal block is disposed so that a protruding position of the terminal block from the tube-shaped body part is set on a side where light is not advanced when the motor is mounted on an optical device on which the motor is to be mounted.
